(19) United States
(12) Patent Application Publication
(10) Pub. No.: US 2004/0105719 A1
(43) Pub. Date: Jun. 3, 2004

(54) Articulated support arm for medical devices

(76) Inventor: Robert Jeffrey Parrott, Owen Sound (CA)

Correspondence Address: Ogilvy Renault, Suite 1600, 1981 McGill College Avenue, Montreal, QC, H3A 2Y3, CA

(21) Appl. No.: 10/714,902

(22) Filed: Nov. 18, 2003

Related U.S. Application Data
(60) Provisional application No. 60/429,548, filed on Nov. 29, 2002.

(51) Int. Cl. F16D 3/00; F16C 11/00

(52) U.S. Cl. 403/84

(57) ABSTRACT

An articulable joint is provided for use with at least two support arms, the joint comprising a front disc and a rear disc, each connected to respective support arms, the front disc rotatably connected to the rear disc around a shoulder bolt. The joint further includes a clutch washer located between the front and rear discs, the clutch washer having a front surface abutting the front disc and a rear surface located adjacent the rear disc, the rear surface of the washer having a plurality of spaced apart sockets, each socket configured for receiving a ball bearing therein. A pressure application means is releasably connected to the front disc and extends therethrough engaging the clutch washer for applying adjustable pressure to the clutch washer, thereby adjusting frictional resistance to, rotation of the front disc relative to the rear disc.

### FIELD OF THE INVENTION

The invention relates to an articulated arm and more particularly to an articulated arm for medical devices.

### BACKGROUND OF THE INVENTION

Articulated arms are known and can be used in a variety of applications such as for supporting flexible hoses or pipes or for use with medical devices.

Such arms generally include a joint located between arm segments. The joint may be adjusted in order to position the arm segments for use.

One example of a joint for use in an articulated arm can be found in U.S. Pat. No. 5,143,468 (Pausch) issued on Sep. 1, 1992. The joint has two opposing disc-like portions that are spaced apart by spring-loaded ball plungers which include a ball bearing. One of the joint portions includes a series of seats that receive the ball bearings. The position of the joint is dictated by the positioning of the ball bearings within the seats while the spring-loaded ball plungers impede rotation between positions. In order to relocate the position of any of the arms the spring-loaded ball plungers must be unscrewed in order to release the ball bearings from the seats, the joint portions rotated to a position in which the ball bearings are located in a seat and the plungers screwed in to hold the joint in position.

It is therefore desirable to provide an adjustable joint that can be positioned to control the movement and location of the arm segments for use while holding the support arm in a desired position.

### SUMMARY OF THE INVENTION

The present invention provides an articulable joint for use with at least two support arms, the joint comprising a front disc and a rear disc, each connected to respective support arms, the front disc being rotatably connected to the rear disc around a shoulder bolt. The articulable joint further includes a clutch washer located between the front and rear discs, the clutch washer having a front surface abutting the front disc and a rear surface located adjacent the rear disc, the rear surface of the washer having a plurality of spaced apart sockets, each socket configured for receiving a ball bearing within it. Pressure application means, is releasably connected to the front disc and extends through the disc engaging the clutch washer for applying adjustable pressure to the clutch washer, thereby adjusting frictional resistance to rotation of the front disc relative to the rear disc.

### DESCRIPTION OF THE DRAWINGS

The invention will be more clearly understood with reference to the following description and the attached drawings, in which:

FIG. 1 is a perspective view of a preferred embodiment of an articulable support arm of the present invention;

FIG. 2 is a perspective view of a preferred embodiment of an articulated joint used in the articulated support arm of FIG. 1; and

FIG. 3 is an exploded view of the articulable joint of FIG. 2.

### DETAILED DESCRIPTION OF THE INVENTION

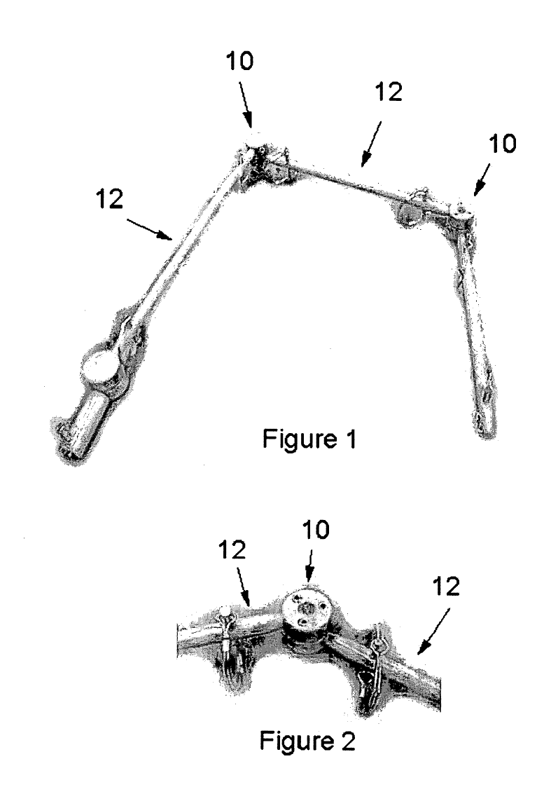

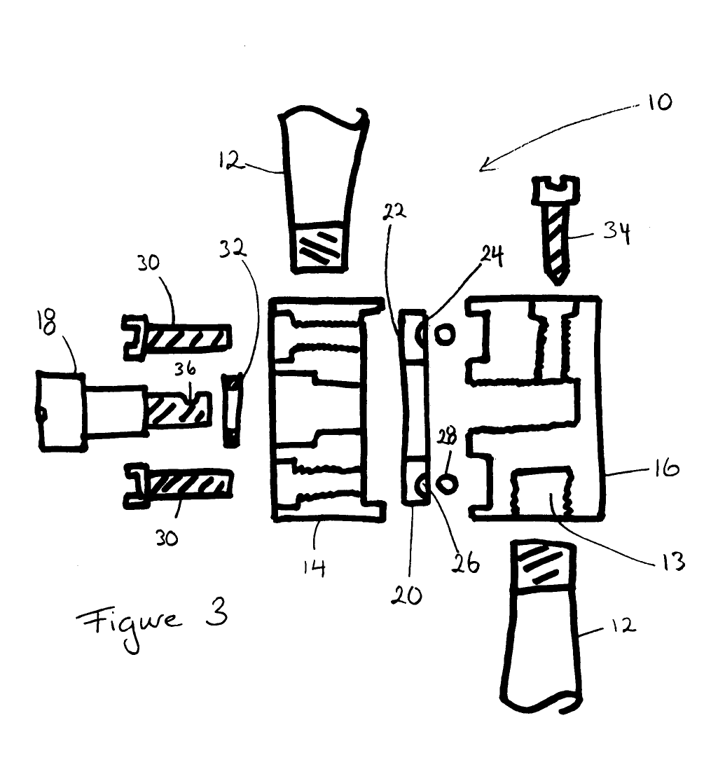

The invention will now be discussed with reference to FIGS. 1 through 3. As can be seen in FIG. 1 an articulable joint according to the present invention is indicated generally at 10. The articulable joint 10 is used to connect at least two support arms 12, as can be seen more clearly in FIG. 2.

Referring now to FIG. 3 a preferred embodiment of an articulable joint 10 is shown having a front disc 14 and a rear disc 16. Each disc 14, 16 is operable to connect to separate support arms 12, preferably by receiving the support arms 12 in sockets 13. The front disc 14 is connected to the rear disc 16 by a shoulder bolt 18 which holds the front disc 14 in a fixed position relative to the rear disc 16 while allowing the front disc 14 to rotate about the shoulder bolt 18.

Located between the front disc 14 and the rear disc 16 is a clutch washer 20 that has a front surface 22 and a rear surface 24. The front surface 22 abuts the front disc 14 and the rear surface 24 is located adjacent the rear disc 16. The rear surface 24 includes at least two sockets 26 that are configured to each receive a ball bearing 28.

The articulable joint 10 also includes at least two set screws 30 that are releasably connected to the front disc 14 and extend through the front disc 14 to cooperate with the clutch washer 20 by applying pressure to it.

The set screws 30 are adjustable in order that the pressure applied to the clutch washer 20 can be adjusted. Other means of applying pressure may be used that are operable to extend through the front disc 14 and apply pressure to the clutch washer 20, while being adjustable relative to the amount of pressure applied.

When pressure is applied to the clutch washer 20 the clutch washer 20 is pushed towards rear disc 16. As the clutch washer 20 moves towards rear disc 16 the ball bearings 28 located in sockets 26 abut the surface of rear disc 16. This pressure creates a frictional force between the ball bearings 28 and the rear disc 16. The combination of the applied pressure by the set screws 30 and the frictional force between the ball bearings 28 and the rear disc 16 allow for continuous relative rotation between the front and rear discs 14, 16 with controlled motion.

The pressure applied to the clutch washer 20 can be adjusted by the positioning of the set screws 30. By adjusting the pressure the frictional resistance between the front and rear discs can be adjusted.

The front and rear discs 14, 16 are preferably made from aluminium. However, other suitable materials may be used that have sufficient strength to support the arms 12 in the required position while being lightweight.

In the preferred embodiment, the clutch washer 20 is made from nylon which provides a surface that is self lubricating allowing for free rotating of the discs 14, 16 around the clutch washer 20 while minimising any damage to the abutting surfaces of the discs 14,16 adjacent the washer 20. Other material can be used that will allow for rotating of the discs 14,16 about the clutch washer 20, such as Teflon™, metals, ceramics, plastics, and carbon composites.

The ball bearings 28 are preferably made from stainless steel. Any material may be used that will withstand the pressure being applied by the set screws 30 while allowing the ball bearings 28 to move across the surface of the rear disc 16. Metals, plastics, ceramics or other materials may be used depending on design considerations.

The use of the joint 10 will now be discussed with reference to FIGS. 1 through 3. The support arms 12 have a threaded end that is secured in a socket 13 within each of the front disc 14 and rear disc 16. A shoulder bolt 18 with a washer 32 is threaded into the rear disc 16 and held in place with a set screw 34 which engages a key 36 in the threaded end of the shoulder bolt 18. In this manner, therefore the front disc 14 freely rotates on the shoulder portion of the bolt 18 while retaining a fixed position relative to the rear disc 16. A clutch washer 20 with ball bearings 28 includes spherical sockets 26 and is positioned between mating faces of the front disc 14 and rear disc 16. Three set screws 30 are threaded into bores through front disc 14 and exert pressure on the clutch washer 20. The amount of pressure exerted is fixed in the manufacture of the joint by measuring torque for example. The set screws 30 maintain constant pressure on the clutch washer 20 which permits relative rotation of front disc 14 on the rear disc 16, however with frictional resistance of a controlled amount. Due to frictional engagement between the threaded shanks of the set screws 30 and the threaded bores of the front disc 14, the set screws 30 remain in position and do not loosen or decrease pressure on the clutch washer 20.

Once the set screws 30 are in the desired position and a suitable amount of pressure is applied to the clutch washer the articulated arm can be used and the support arms 12 can be moved relative to each other.

The above description is intended in an illustrative rather than a restrictive sense. Variations may be apparent to persons skilled in such apparatus without departing from the spirit and scope of the invention as defined by the claims set out below.

1. An articulable joint for use with at least two support arms, the joint comprising:
(a) a front disc and a rear disc, each connected to respective support arms, the front disc rotatably connected to the rear disc around a shoulder bolt;
(b) a clutch washer located between the front and rear discs, the clutch washer having a front surface abutting the front disc and a rear surface located adjacent the rear disc, the rear surface of the washer having a plurality of spaced apart sockets, each socket configured for receiving a ball bearing therein; and
(c) pressure application means, releasably connected to the front disc and extending therethrough engaging the clutch washer for applying adjustable pressure to the clutch washer, thereby adjusting frictional resistance to rotation of the front disc relative to the rear disc.

2. An articulable joint according to claim 1, wherein the pressure application means comprises a plurality of set screws.

3. An articulable joint according to claim 1, wherein the pressure application means comprises three set screws disposed coaxially relative to the front disc.

4. An articulable joint according to claim 1, wherein the shoulder bolt is fixedly attached to the rear disc to impede rotation of the shoulder bolt relative to the rear disc.
